(19) United States
(12) Patent Application Publication
(10) Pub. No.: US 2008/0229378 A1
(43) Pub. Date: Sep. 18, 2008

(54) System and Method of Distributing Audio and Video Signals

(75) Inventor: Paul Scherek, Victoria (AU)

Correspondence Address: STEVENS DAVIS LLP, 1615 L STREET NW, SUITE 850, WASHINGTON, DC, 20036, US

(73) Assignee: LEAF AUDIO PTY. LTD., Braeside, VI (AU)

(21) Appl. No.: 11/718,880

(22) PCT Filed: Nov. 9, 2005
(86) PCT No.: PCT/AU2005/001713

§ 371 Date: Nov. 13, 2007

(30) Foreign Application Priority Data
Nov. 9, 2004 (AU) 2004906398

(51) Int. Cl. H04N 7/173

(52) U.S. Cl. 725/127

(57) ABSTRACT

A system (200) for distributing audio and video signals including a source location (202) having one or more devices (204, 206, 208, 210) producing an audio signal and an analogue video signal is provided. At least one display and audio receiver (222) at a remote location (220) is also provided and a single cable (100) including at least three unshielded twisted pairs (102, 104, 106) is operably connected between the source location (200) and the at least one remote display and audio receiver (222) with the cable (100) transmitting the source signals to the display and audio receiver (222) at the remote location (202). The analogue video signal is converted to a balanced signal before transmission from the source (202) to the remote location (220) over a first twisted pair (102) and reconverted to an unbalanced signal at the remote location (220). The audio signal is transmitted over a second twisted pair (104) to the remote location (220) and a control signal for controlling the source signals from the remote location (220) is transmitted on a third twisted pair (106) to the source location (202).

### FIELD OF THE INVENTION

This invention relates generally to a system and method of distributing both audio and video signals to one or more locations from a central location.

### BACKGROUND TO THE INVENTION

In recent years, the number of homes having digital versatile disc (DVD) players, pay television subscriptions or home theatre systems has increased substantially. It is often the case that owners of home theatre systems would like to use them in more than one room, however due to the size and cost of the equipment involved, it is impractical to purchase more equipment for placement in other rooms of the home.

Previously, home theatre systems have been installed in homes using a number of different cables, each for carrying the different signals required for the system to operate. This is undesirable as it is difficult and costly to install multiple cables in addition to the cost associated with each cable.

Extending a home theatre installation to many rooms in a premises by extending the existing cabling arrangement means a substantial cost that consumers clearly seek to avoid. Coaxial cable has been used to carry audio and video signals from the source to the equipment providing the viewing means e.g. television. However, it is not practical to run length of coaxial cable to other locations in the home as coaxial cable is expensive to purchase and the video and audio quality degrades when transmitted through longer lengths of the cable.

A further problem exists in that audio generally requires two channels, and in systems such as home theatres, six or more channels are often used. Therefore, transmission of audio often requires a large number of cables which are both expensive to purchase and bulky to install.

It is therefore desirable to provide a means and method of distributing audio and video signals that overcome or alleviate one or more of the above described disadvantages.

### SUMMARY OF THE INVENTION

According to one aspect, the present invention provides a system for distributing audio and video signals including:

a source location having one or more devices producing:

an audio signal, and

an analogue video signal;

at least one display and audio receiver at a remote location wherein a single cable including at least three unshielded twisted pairs is operably connected between the source location and the at least one remote display and audio receiver, said cable transmitting the source signals to the display and audio receiver at the remote location,

wherein the analogue video signal is converted to a balanced signal before transmission from the source to the remote location over a first twisted pair and reconverted to an unbalanced signal at the remote location,

the audio signal is transmitted over a second twisted pair to the remote location and

a control signal for controlling the source signals from the remote location to the source location is transmitted on a third twisted pair.

Advantageously, a cable comprising unshielded twisted pairs is relatively inexpensive and readily available to purchase. A further advantage of the system is that multiple audio channels may be transmitted, and in a particularly preferred embodiment, multiple audio channels may be multiplexed and transmitted on a single unshielded twisted pair.

In a preferred embodiment of the invention, the video signal is balanced by a first transconductance amplifier which converts the unbalanced video signal to a balanced signal. Balancing the video signal prior to transmission reduces the potential for the signal to be electrically interfered with by other signals being transmitted by the cable, or by other cables in the vicinity.

If the devices at the source location do not provide digital audio output, it is necessary to convert the audio signal from an analogue signal to a digital signal for transmission. The conversion of the analogue signal to a digital signal may be performed by an analogue to digital converter. Further, the volume, bass or treble components of the signal may be adjusted in either the analogue or digital form.

In a preferred embodiment, the system may also include a power supply and a control device. The control device may be operably configured to receive a control signal from the remote location via the third twisted pair to enable control of the devices at the source location, such as a home theatre system, at the remote location. Preferably, the power supply is transmitted on a separate twisted pair of the single cable, ie, a fourth twisted pair.

Preferably, the twisted pair conducting the power signal is provided with a source of direct current (DC) power which may be used to provide power to the control devices in the remote location. The twisted pair conducting control signals may transmit control signals from the remote location to the central location in order to control the operation of components in a home theatre system. The control signals may be generated by a keypad control device or from an IR remote control device or both.

According to another aspect, the present invention provides a method of distributing audio and analogue video signals from a source location to at least one remote location, the remote location including a display and audio receiver connected by a single cable including at least three unshielded twisted pairs, the method including the steps of:

converting the analogue video signal to a balanced video signal;

transmitting the audio signal from the source location to the remote location over a first twisted pair;

transmitting the balanced video signal from the source location to the remote location over the second twisted pair;

transmitting the control signal remote location to the source location over the third twisted pair to enable control of the audio and video source from the remote location; and

reconverting the balanced video signal to its original form at the remote location.

The method may further include any one or more of the following steps:

connecting a power supply to a fourth twisted pair to provide a power supply to a control device at the remote location;

digitising an analogue audio signal for transmission over the first twisted pair;

reconverting the digitised audio signal for an analogue signal at the remote location.

In a preferred embodiment the source may include one or more of a television, video player, digital versatile disc (DVD) player or the like. Preferably, the audio signal will be a multi-channel audio supply.

It will also be appreciated that an additional power supply may be carried by a separate cable, or alternatively may be provided at each remote location.

Preferably, the single cable includes four unshielded twisted pairs, e.g. category 5 cable. Although such cable is usually used in the transfer of data in a digital format, in the instant invention this cable may be used to carry both the audio and video signals.

In one embodiment, the audio and video signals may be provided by the same device located at the source location. However, it will also be appreciated that the audio and video signals may be provided by different devices located at the source location. For example, when viewing a sporting event on a television, consumers sometimes elect to listen to music from either a radio broadcast, compact disc or similar.

The system may further include a level trimming system for controlling the audio level from multiple source devices. The level trimming system includes an adjustment factor for each device which may be stored in a non-volatile memory. The adjustment factor ensures that regardless of which device the audio signal is selected from, the audio signal is trimmed so that the volume of any received audio signal at the remote location will remain substantially the same irrespective of the device emitting the signal.

It will be appreciated by those of skill in the relevant field, that any other suitable twisted pair cable, such as those used in networking computers, may be used. A further advantage in using such cables is that they are commercially available, inexpensive and may be terminated by readily available RJ45 connectors or screw terminals.

Preferably, the remote display means is a television, projector, monitor or other device capable of displaying video information.

In a preferred embodiment, a first transconductance amplifier is housed within an interface box. The interface box may further include a power supply, a control signal interface and an IR code interface. A second transconductance amplifier may be housed within a remote location, together with an input device, such as a keypad for inputting control signals, or an IR receiver to re-generate IR codes and a power supply filter to supply filtered power to the second transconductance amplifier.

The method may further include adjusting either volume, bass or treble in either the analogue or digital stage.

### BRIEF DESCRIPTION OF THE DRAWINGS

A preferred embodiment of the invention is now described with reference to the accompanying drawings in which the distributed audio visual system is illustrated. It is to be understood that the distributed audio visual system of the present invention is not limited to the preferred embodiment illustrated in the drawings.

FIG. 1 is a schematic diagram of four twisted pair cable.

FIG. 2 is a schematic overview of a distributed home theatre system in accordance with the present invention.

FIG. 3 is a schematic diagram of a partial home theatre system shown in FIG. 2.

FIG. 4 is a detailed schematic diagram of a distributed home theatre system shown in FIG. 2.

### DETAILED DESCRIPTION OF A PREFERRED EMBODIMENT OF THE INVENTION

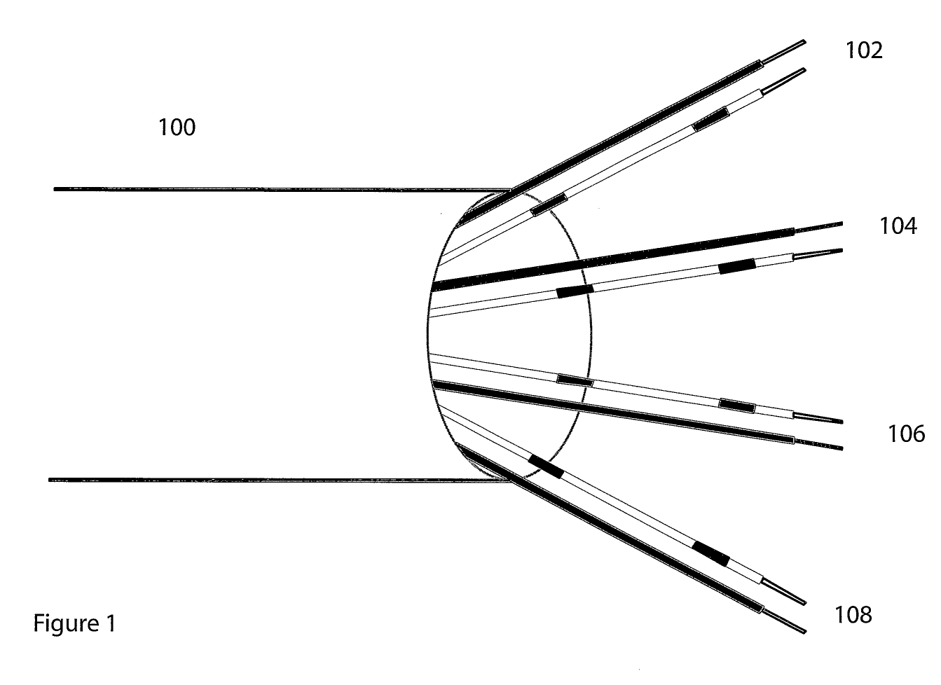

Referring now to FIG. 1, there is shown a cable 100, including four twisted pairs 102, 104, 106 and 108. Pair 102 conducts an analogue video signal from a device at source location (not shown) to a remote receiver (also not shown). Similarly pairs 104, 106 and 108 conduct an audio signal, power and a control signal respectively, from the source location to the remote location.

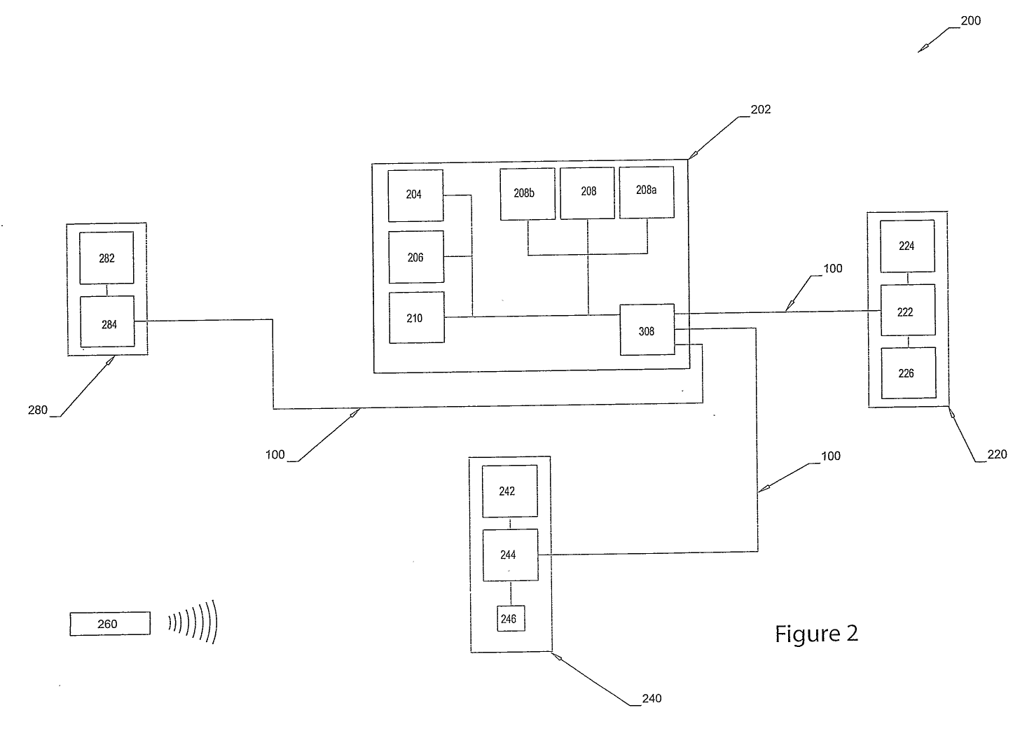

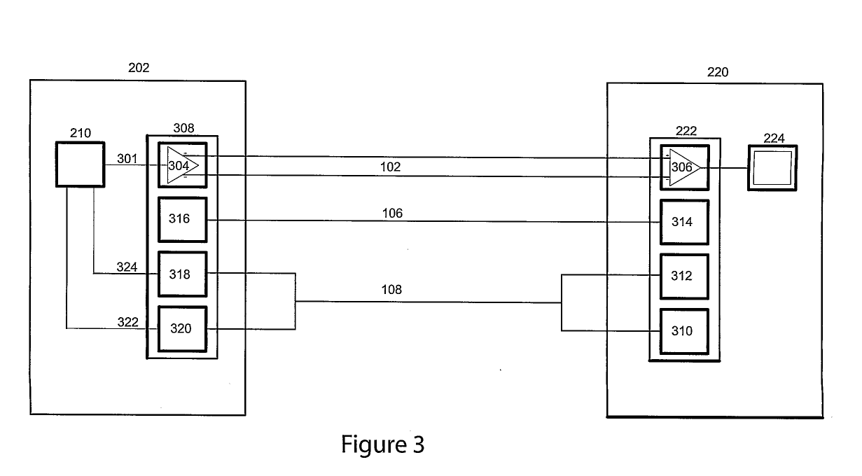

FIG. 2 shows an overview of home theatre system 200 including a source location 202. Source location 202 includes a television receiver 204, video recorder 206 and DVD player 210, each having an audio and a video signal. Each device 204, 206 and 210 in source location 202, is connected to an interface 308 (see FIG. 3). The source location may also include a stereo system 208 including speakers 208a and 208b. The stereo system 208 is also connected to interface 308.

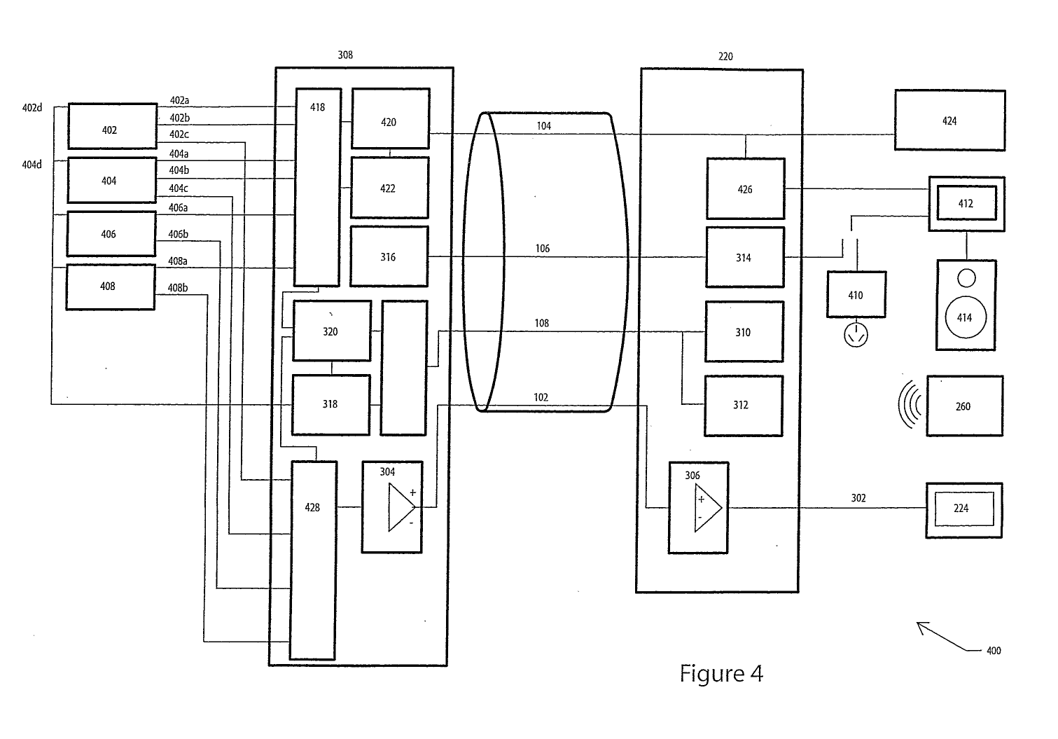

Cable 100 connects each of the devices 204, 206 and 210 in the source location 202 via interface 308, to each remote location 220, 240, 280. Cable 100 connects remote location 220 via control panel 222 to interface 308 at the source location 202. Control panel 222 allows a user of the home theatre system 200 to select a channel for viewing and listening on display devices 224 and/or audio device 226. For further details on control panel 222 see FIG. 4.

Display device 224, a television monitor, is connected to control panel 222 via ordinary 75 ohm coaxial cable or similar. An audio device 226, a power amplifier and loud speaker, are also connected to control panel 222. It will be noted that power amplifier 226 may be connected to a mains power supply (not shown) or it may derive power from twisted pair 106 in cable 100 (FIG. 1).

Remote location 240 also includes a display device 242 in the form of a television monitor. Television monitor 242 is also connected to a control panel 244 which in turn is connected via cable 100 to interface 308 in primary source 202. In addition to control panel 244, remote location 240 also includes IR receiver 246. The IR receiver 246, is connected to control panel 244, may be used with remote control 260 to control which device (204, 206, 210) from source location 202 is shown on television 242.

A further remote location 280, includes display means in the form of projector 282 also controlled by a control panel 284. Again, remote location 280 is connected to the primary source by cable 100 carrying a video signal, an audio signal, power and a control signal via twisted pairs 102 104, 106 and 108 in cable 100 (see FIG. 1).

Projector 282 is controlled by control pad 284 from which the user can select a device 204, 206, 210 from source location 202. It will be appreciated that an arrangement such as home theatre system 200, allows the television receiver 204, video player 206 or DVD player 210 at the source location 202 to be watched in any of the remote locations 220, 240 or 280. A further advantage is that users in each of the respective remote locations may choose to watch the same device, or a different device 204, 206, 210.

Referring now to FIG. 3 there is shown the devices at the source location (202 FIG. 2) connected to remote location 220. The source location 202 includes video source 210 in the form of a DVD player and interface 308. The video source accepts control data 324 in IR form from the IR receiver 312 via interface 318, as well as control data 322 in IR form generated by the keypad 310 via interface 320. The video device outputs a video signal 301.

Interface 308 includes transconductance amplifier 304, power supply 316, IR code interface 318 and control interface 320. The video signal is transmitted by co-axial cable 301 and converted by transconductance amplifier 304 into a balanced signal. As transconductance amplifier 304 is connected via twisted pair 102 to the transconductance amplifier 306 in remote location 220, the balanced signal is transmitted from the source location 202 to remote location 220. Before the video signal is able to be displayed at remote location, television 224, the signal is reconverted by amplifier 306 to an unbalanced signal. The signal is passed to television monitor 224 via 75 ohm coaxial cable or similar 302 for viewing in remote location 220.

Power supply 316 is connected via twisted pair 106 to power filter 314 in remote location 220. Power supply 316 is a DC power supply and provides power to keypad 310 and power amplifier 412 (FIG. 4).

IR code interface 318 in source location 202 is connected to the IR code receiver 312 in the remote location 220 by twisted pair 108, similarly control interface 320 is connected via twisted pair 108 to keypad 310 in remote location 220. Both the IR data receiver 312 and keypad 310 provide users with greater functionality. The IR data receiver permits the use of the remote control 260 in remote locations, 220, 240 and 280. Alternatively, users may select and control the audio and video signals from control keypad 310.

FIG. 4 shows another embodiment of a home theatre system in greater detail. FIG. 4 shows source location including four devices 402, 404, 406 and 408, each having an audio signal and a video signal. Sources 402 and 404 include both analogue and digital audio 402a, 402b and a video signal 402c.

For example, devices 402, 404, 406 and 408 may include televisions, DVD players, stereo systems or video players.

Referring now to source 402, it can be seen that both the analogue and digital audio signals 402a and 402b respectively, are transmitted into an audio switch matrix 418. The switch matrix 418 is controlled from the remote location 220 via twisted pair 108 and control interface 320. If the device 402 is providing only an audio analogue output, then analogue to digital converter 422 will convert the signal to a digital signal for transmitting via twisted pair 104 to remote location 220. However, if source 402 is supplying a digital audio, then this will be selected by the digital audio selector 420 and passed directly to the remote location via twisted pair 104.

Audio signals 402a and 402b may be processed by audio matrix 418 to enable volume and tonal adjustments, as well as apply level trimming. Audio matrix 418 includes a non volatile memory (not shown) for storing adjustment factors. Level trimming advantageously provides the same audio output (i.e. volume) regardless of the source of audio which the user selects. Therefore, when a user in a remote location 220 changes between sources, a change in volume through with the keypad 310 or via remote control 260 should not be necessary.

Video signal 402c is transmitted to video switch matrix 428, controlled via twisted pair 108 from remote location 220, and subsequently converted by transconductance amplifier 304 to a balanced signal. The balanced signal is then transmitted via twisted pair 102 to transconductance amplifier 306 in a remote location for reconversion to an unbalanced signal. The unbalanced video signal is able to be displayed on television monitor 224 via 75 ohm coaxial cable or similar 302.

Each of the devices also provides a control port, 402d, 404d, 406d and 408d. The control port 402d, for example, is transmitted from the IR data interface 318 and the output of control interface 320 to be passed via twisted pair 108 from keypad 310 and IR receiver 312 in remote location 306.

IR receiver 312 receives IR signals from remote control 260 to select and control audio and video devices from the source location 202. The IR signals are transmitted via twisted pair 108, through IR data interface 318 to device 402 to effect the user's selection.

Power is supplied from power supply 316 via twisted pair 106 to the power filter 314 at interface 306 in remote location 220. The power filter 314 then may supply power amplifier 412 or amplifier 412 may be supplied by the mains power supply 410. Power amplifier 412 receives the output of digital to analogue converter 426 to amplify the analogue audio for output at loudspeaker 414. The digital audio carried by pair 104 may alternatively be connected to a home theatre sound system 424. This home theatre sound system 424 is a stand-alone third party unit that converts the digital signal to multiple channel analogue audio and provides amplification and speakers.

It will be understood that the invention disclosed and defined in this specification extends to all alternative combinations of two or more of the individual features mentioned or evident from the text or drawings. All of these different combinations constitute various alternative aspects of the invention.

1. A system for distributing audio and video signals including:
a source location having one or more devices producing:
an audio signal, and
an analogue video signal;
at least one display and audio receiver at a remote location wherein a single cable including at least three unshielded twisted pairs is operably connected between the source location and the at least one remote display and audio receiver, said cable transmitting the source signals to the display and audio receiver at the remote location,
wherein the analogue video signal is converted to a balanced signal before transmission from the source to the remote location over a first twisted pair and reconverted to an unbalanced signal at the remote location,
the audio signal is transmitted over a second twisted pair to the remote location and
a control signal for controlling the source signals from the remote location to the source location is transmitted on a third twisted pair.

2. A system as claimed in claim 1 wherein the video signal is balanced by a first transconductance amplifier which converts the unbalanced video signal to a balanced signal.

3. A system as claimed in claim 1 further including an analogue to digital converter.

4. A system as claimed in claim 1 further including a power supply.

5. A system as claimed in claim 4 wherein the power supply is transmitted on a fourth twisted pair from the source location to the remote location to provide a source of direct current to a control device in the remote location.

6. A system as claimed in claim 1 further including a control device for controlling the devices at the source location from the remote location.

7. A system as claimed in claim 6 wherein the control device is a keypad.

8. A system as claimed in claim 6 wherein the control device is a remote control.

9. A system as claimed in claim 1 wherein the device at the source location includes one or more of a television, video player, digital versatile disc (DVD) player.

10. A system as claimed in claim 1 wherein the audio signal is a multi-channel audio supply.

11. A system as claimed in claim 1 wherein the audio and video signals are provided by a single device located at the source location.

12. A system as claimed in claim 1 wherein the audio and video signals are provided by different devices located at the source location.

13. A system as claimed in claim 1 further including a level trimming system for controlling the audio level from multiple devices.

14. A system as claimed in claim 13 wherein the level trimming system includes an adjustment factor for each device which is stored in a non-volatile memory.

15. A system as claimed in claim 14 wherein the cable is a category 5 cable.

16. A method of distributing audio and analogue video signals from a source location to at least one remote location, the remote location including a display and audio receiver connected by a single cable including at least three unshielded twisted pairs, the method including the steps of:
concerting the analogue video signal to a balanced video signal;
transmitting the audio signal from the source location to the remote location over a first twisted pair;
transmitting the balanced video signal from the source location to the remote location over the second twisted pair;
transmitting the control signal from the remote location to the source location over the third twisted pair to enable control of the audio and video source from the remote location; and
reconverting the balanced video signal to its original form at the remote location.

17. A method as claimed in claim 16 further including the step of:
connecting a power supply to a fourth twisted pair to provide a power supply to a control device at the remote location.

18. A method as claimed in claim 16 further including the step of:
digitising an analogue audio signal for transmission over the first twisted pair.

19. A method as claimed in claim 18 further including the step of:
reconverting the digitised audio signal for an analogue signal at the remote location.
